(19) United States
(12) Patent Application Publication
(10) Pub. No.: US 2014/0169325 A1
(43) Pub. Date: Jun. 19, 2014

(54) CARRIER DEPLOYMENT METHOD FOR REDUCED BANDWIDTH MTC DEVICES

(71) Applicant: NOKIA SIEMENS NETWORKS OY, Espoo (FI)

(72) Inventors: Rapeepat RATASUK, Hoffman Estates, IL (US); Sassan IRAJI, Espoo (FI)

(73) Assignee: NOKIA SIEMENS NETWORKS OY, Espoo (FI)

(21) Appl. No.: 13/714,584

(22) Filed: Dec. 14, 2012

(51) Int. Cl. H04W 74/04

(52) U.S. Cl. CPC H04W 74/04
USPC 370/330

(57) ABSTRACT

A method and apparatus can be configured to perform the steps of overlapping a first carrier band with a second carrier band. The method may further include allocating at least one time-frequency resource of the first carrier band to a first channel. The method may further include allocating at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

### BACKGROUND

1. Field

Embodiments of the invention relate to carrier deployment for supporting devices that operate using a reduced bandwidth, such as, but not limited to, machine-type communication (MTC) devices using Long-term Evolution technologies.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method can include overlapping a first carrier band with a second carrier band. The method can also include allocating at least one time-frequency resource of the first carrier band to a first channel. The method can also include allocating at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

In the method of the first embodiment, overlapping the first carrier band with the second carrier band includes overlapping the first carrier band with the second carrier band within a wider carrier band.

In the method of the first embodiment, the overlapping portion contains a control channel.

In the method of the first embodiment, the at least one time-frequency resource of the first carrier band and the at least one time-frequency resource of the second carrier band are configured to use time-division multiplexing.

In the method of the first embodiment, the first carrier band and the second carrier band share at least one control-channel base sequence.

In the method of the first embodiment, the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

In the method of the first embodiment, at least one of the first carrier band and the second carrier band transmits machine-type communications.

According to a second embodiment, an apparatus can include at least one processor. The apparatus can also include at least one memory including computer program code. The at least one memory and the computer program code can be configured, with the at least one processor, to cause the apparatus at least to overlap a first carrier band with a second carrier band. The apparatus also allocates at least one time-frequency resource of the first carrier band to a first channel. The apparatus also allocates at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

In the apparatus of the second embodiment, overlapping the first carrier band with the second carrier band includes overlapping the first carrier band with the second carrier band within a wider carrier band.

In the apparatus of the second embodiment, the overlapping portion contains a control channel.

In the apparatus of the second embodiment, the at least one time-frequency resource of the first carrier and the at least one time-frequency resource of the second carrier band are configured to use time-division multiplexing.

In the apparatus of the second embodiment, the first carrier band and the second carrier band share at least one control-channel base sequence.

In the apparatus of the second embodiment, the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

In the apparatus of the second embodiment, at least one of the first carrier band and the second carrier band transmits machine-type communications.

According to a third embodiment, a computer program product, embodied on a computer readable medium, is configured to control a processor to perform a process comprising overlapping a first carrier band with a second carrier band. The process also includes allocating at least one time-frequency resource of the first carrier band to a first channel. The process also includes allocating at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

According to a fourth embodiment, a method can include receiving, by a receiving device, transmissions via a first carrier band. At least a portion of the first carrier band overlaps a second carrier band. The transmissions include at least one time-frequency resource that is allocated to a first channel. The transmissions further include at least one time-frequency resource shared by the first carrier band and the second carrier band within the overlapping portion between the first carrier band and the second carrier band. The shared time-frequency resource is allocated to the first channel.

In the method of the fourth embodiment, receiving transmissions via the first carrier band includes receiving transmissions via the first carrier band overlapping the second carrier band within a wider carrier band.

In the method of the fourth embodiment, the overlapping portion contains a control channel.

In the method of the fourth embodiment, the at least one time-frequency resource of the first carrier band and the at least one time-frequency resource of the second carrier band are configured to use time-division multiplexing.

In the method of the fourth embodiment, receiving transmissions via the first carrier band includes receiving the transmissions by a machine-type communications device.

In the method of the fourth embodiment, the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

According to a fifth embodiment, an apparatus can include at least one processor. The apparatus can also include at least one memory including computer program code. The at least one memory and the computer program code are configured, with the at least one processor, to cause the apparatus at least to receive, by a receiving device, transmissions via a first carrier band. At least a portion of the first carrier band overlaps a second carrier band, the transmissions include at least one time-frequency resource that is allocated to a first channel, the transmissions further include at least one time-frequency resource shared by the first carrier band and the second carrier band within the overlapping portion between the first carrier band and the second carrier band, and the shared time-frequency resource is allocated to the first channel.

In the apparatus of the fifth embodiment, receiving transmissions via the first carrier band includes receiving transmissions via the first carrier band overlapping the second carrier band within a wider carrier band.

In the apparatus of the fifth embodiment, the overlapping portion contains a control channel.

In the apparatus of the fifth embodiment, the at least one time-frequency resource of the first carrier band and the at least one time-frequency resource of the second carrier band are configured to use time-division multiplexing.

In the apparatus of the fifth embodiment, receiving transmissions via the first carrier band includes receiving the transmissions by a machine-type communications device.

In the apparatus of the fifth embodiment, the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

According to a sixth embodiment, a computer program product, embodied on a computer readable medium, is configured to control a processor to perform a process including receiving, by a receiving device, transmissions via a first carrier band. At least a portion of the first carrier band overlaps a second carrier band, the transmissions include at least one time-frequency resource that is allocated to a first channel, the transmissions further include at least one time-frequency resource shared by the first carrier band and the second carrier band within the overlapping portion between the first carrier band and the second carrier band, and the shared time-frequency resource is allocated to the first channel.

According to a seventh embodiment, a system includes a first apparatus. The first apparatus includes at least one first processor, and at least one first memory including first computer program code. The at least one first memory and the first computer program code are configured, with the at least one first processor, to cause the first apparatus at least to overlap a first carrier band with a second carrier band. The first apparatus also allocates at least one time-frequency resource of the first carrier band to a first channel. The first apparatus also allocates at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels. The system also includes a second apparatus. The second apparatus includes at least one second processor, and at least one second memory including second computer program code. The at least one second memory and the second computer program code is configured, with the at least one second processor, to cause the second apparatus at least to receive, by a receiving device, transmissions via the first carrier band. At least a portion of the first carrier band overlaps the second carrier band, the transmissions include the at least one time-frequency resource that is allocated to the first channel, the transmissions further include the at least one time-frequency resource shared by the first carrier band and the second carrier band within the overlapping portion between the first carrier band and the second carrier band, and the shared time-frequency resource is allocated to the first channel.

### BRIEF DESCRIPTION OF THE DRAWINGS

For proper understanding of the invention, reference should be made to the accompanying drawings, wherein:

FIG. 1 illustrates, according to one embodiment, a narrow-band carrier.

FIG. 2 illustrates, according to one embodiment, deploying multiple carriers, where, for each carrier, one resource-block pair is allocated to a control channel.

FIG. 3 illustrates, according to one embodiment, deploying carriers when two or more resource-blocks pairs are allocated per carrier to a control channel.

FIG. 4(a) illustrates, according to one embodiment, deploying multiple carriers where the carriers share one or more resource blocks.

FIG. 4(b) illustrates, according to another embodiment, deploying multiple carriers where the carriers share one or more resource blocks.

FIG. 5(a) illustrates control channel overhead when using two carriers according to one embodiment;

FIG. 5(b) illustrates reductions in control channel overhead that can be achieved according to one embodiment;

FIG. 6(a) illustrates a machine-type-communication (MTC) region when using two carriers according to one embodiment;

FIG. 6(b) illustrates achieving increments of finer granularity when forming/expanding MTC regions according to one embodiment;

FIG. 7 illustrates a flow diagram of a method according to an embodiment;

FIG. 8 illustrates an apparatus according to another embodiment;

FIG. 9 illustrates an apparatus according to another embodiment;

FIG. 10 illustrates an apparatus according to another embodiment;

### DETAILED DESCRIPTION

Machine type communication (MTC) comprises data communication among devices without requiring human interaction. MTC can include, for example, data communication between devices and a server, or communication between a plurality of devices. Machine type communication can also be known as machine-to-machine (M2M) communication. Services that utilize MTC can include security services, tracking services, payment services, smart grid services, and remote maintenance/monitoring services. MTC can also be utilized in cases where the devices have low mobility. MTC communication can tolerate delay. MTC communication can occur between a large number of different devices. MTC communication can also be characterized by small and infrequent data transmission. MTC communication can also be highly reliable, time-controlled, and group-based.

Currently, MTC services can be supported at a physical layer using systems that operate using the Global System for Mobile Communications (GSM) standard. In addition to the GSM standard, MTC services can also be supported by services that operate using the Code Division Multiple Access standard (CDMA), the Wideband Code Division Multiple Access standard (WCDMA), and the Worldwide Interoperability for Microwave Access standard (WiMAX), for example. Inexpensive devices, in terms of manufacturing cost, are widely available in GSM. With the widespread introduction of LTE, and the decommissioning of legacy systems, migration of MTC devices to LTE is being considered by cellular operators.

In the interest of having comparable MTC-device-manufacturing costs between LTE and GSM, cost reduction techniques for MTC devices in LTE have been studied. The different techniques that have been considered include reduction of the bandwidth supported by the devices, reduction of the peak data rate of the devices, and reduction of maximum transmit power of the devices. Cost reduction for MTC devices in LTE can also be achieved by equipping the devices with a single radio-frequency (RF) receiver chain, and by using half-duplex operations in the devices.

As mentioned above, one of the techniques of cost reduction for MTC devices in LTE is bandwidth reduction. Bandwidth reduction may include limiting the reception capability of the devices so that they can only receive a reduced bandwidth. Currently, in order to operate within an LTE system, a user equipment (UE) is required to be able to access/receive a system bandwidth of up to 20 MHz. This upper-limit bandwidth requirement for operating within an LTE system can be reduced for low-cost MTC devices. By reducing the upper-limit bandwidth requirement, MTC devices can be built at lower cost. As such, reduction in complexity and cost can be achieved for these MTC devices in LTE.

Specifically, the requirements for operating MTC devices within an LTE system can be reduced by requiring MTC devices to support a bandwidth that is less than the previous 20 MHz requirement. For example, MTC devices can be required to support only a 1.4 MHz bandwidth.

Certain features can be included in future modifications of the LTE standard. For example, in Downlink (DL), a first option can be to reduce bandwidth for both RF and baseband transmissions. In DL, a second option can be to reduce bandwidth for only baseband transmissions for both data channel and control channels. In DL, a third option can be to reduce bandwidth for a data channel for baseband transmissions only, while the control channels can be still allowed to use the carrier bandwidth. In uplink (UL), a first option is to reduce bandwidth for both RF and baseband transmissions. In UL, a second option is to implement no bandwidth reductions.

In the possible features described above, for UL, the first option can be an option for bandwidth reduction. In one embodiment, a bandwidth of 1.4 MHz can be the maximum bandwidth that is supported by low-cost MTC devices. As such, according to this embodiment, for communications that are transmitted using a larger bandwidth, the MTC devices can only see a narrowband, such as a 1.4 MHz strip, for example.

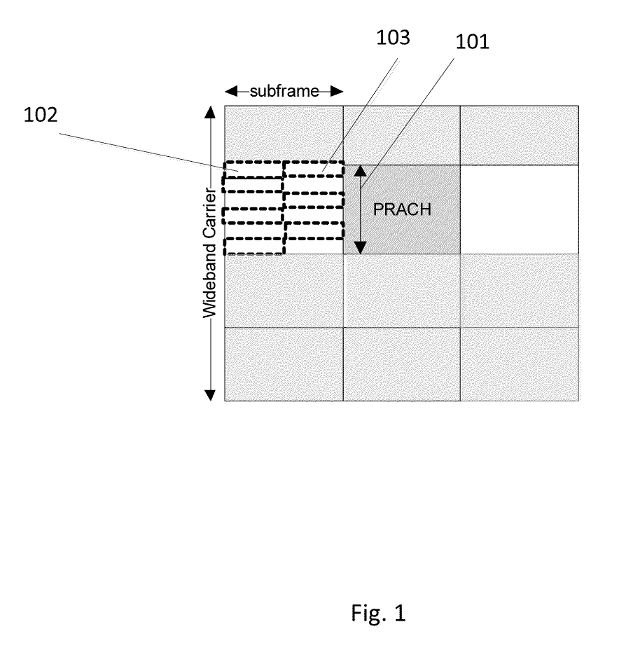

FIG. 1 illustrates, according to one embodiment, a narrow-band carrier. As described above, in one embodiment, the band 101 of the narrow-band carrier can be 1.4 MHz. Further, the band of each narrow-band carrier can comprise a plurality of time-frequency resources, such as pairs of resource blocks, for example. For example, resource block 102 and resource block 103 can together form a resource-block pair. A band can comprise a plurality of resource-block pairs. For example, as shown in FIG. 1, band 101 comprises six resource-block pairs. In one embodiment, each narrow-band carrier within a wideband carrier can support a plurality of MTC devices.

If the number of MTC devices is larger than can be supported by a single narrow-band carrier, then several narrow-band carriers can be deployed. For example, several 1.4 MHz carriers can be deployed. Each narrow-band carrier can require its own control channel. For example, each narrow-band carrier can require its own physical uplink control channel (PUCCH).

However, when using multiple narrow-band carriers, with each carrier requiring its own control channel, certain considerations arise. A first consideration relates to determining how to minimize the control channel overhead involved when multiple narrow-band carriers are used. As described above, in one embodiment, each carrier can require its own PUCCH. A second consideration relates to determining how to minimize overall MTC overhead when expanding the MTC region when deploying one or more additional narrow-band carriers. Expanding the MTC region can include expanding the band region that supports transmission with MTC devices. The MTC region can be considered to be the overall, total band region formed by the deployed carriers. When an additional narrow-band carrier is deployed to expand the MTC region, because the additional narrow-band carrier can have a predetermined specific width, the MTC region can possibly be capable of being expanded in only multiples of that specific width. For example, because the additional narrow-band carrier can have a predetermined specific width of 1.4 MHz, the MTC region can possibly be capable of being expanded in only multiples of 1.4 MHz. However, supposing that the MTC region only needs to be expanded a small amount that is less than 1.4 MHz, expanding the MTC region by an entire increment of 1.4 MHz can be considered as creating too much MTC overhead. In view of this second consideration, certain embodiments are directed at expanding MTC regions in increments of finer granularity. For example, some embodiments expand MTC regions in increments of less than 1.4 MHz.

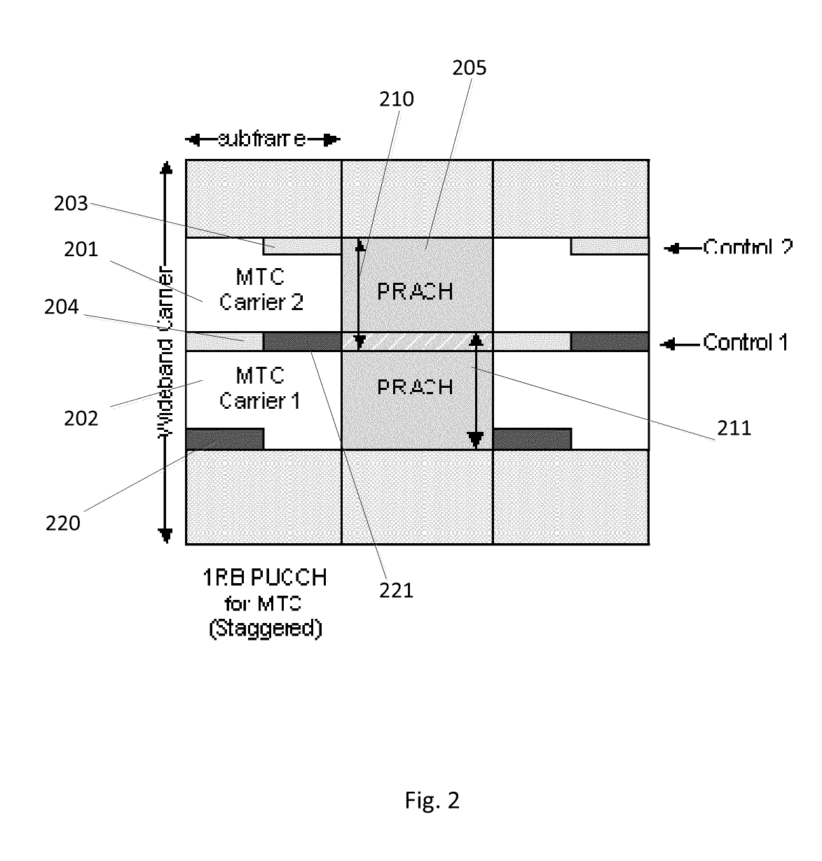

FIG. 2 illustrates, according to one embodiment, deploying multiple carriers, where, for each carrier, one resource-block pair is allocated to a control channel such as a physical uplink control channel, for example. In view of the above considerations, certain embodiments deploy multiple narrow-band carriers. Embodiments of the present invention can be implemented without changes in LTE standards. Certain embodiments can be used as a product-differentiator for a specific network deployment when more than one narrowband carriers are to be deployed within a wideband carrier. For example, the specific network deployment can be a Nokia Siemens Networks™ network deployment. Additionally, embodiments of the present invention are not limited to supporting low-cost MTC devices, as other embodiments can be used for other purposes as well. For example, another purpose can be spectrum sharing between operators.

As shown in FIG. 2, one embodiment deploys UL carriers (201, 202) in a staggered and/or overlapping manner. Specifically, narrow-band carriers 201 and 202 are staggered/overlapped within a larger system bandwidth. The larger system bandwidth can correspond to the bandwidth of a wider carrier band. Narrowband 210 (corresponding to MTC carrier 2) is overlapped with narrowband 211 (corresponding to MTC carrier 1). In one embodiment, each narrow-band carrier has allocated a resource-block pair to a respective control channel. For example, MTC Carrier 2 has allocated resource block 203 and resource block 204 to a physical uplink control channel. The combination of resource block 203 and resource block form a resource-block pair. Similarly, MTC Carrier 1 has allocated resource block 220 and resource block 221 to a physical uplink control channel.

Within the overlapping portion between narrow-band carrier 201 and narrow-band carrier 202, the two carriers share at least one resource-block pair. For example, MTC Carrier 1 and MTC Carrier 2 share the resource-block pair comprising resource block 204 and resource block 221.

In one embodiment, by staggering/overlapping the narrowband carriers in the manner shown by FIG. 2, a smaller control channel overhead can be achieved for the narrowband carriers. Further, by staggering/overlapping the narrowband carriers, embodiments of the present invention can support arbitrary physical uplink shared channel (PUSCH) sizes. For example the PUSCH sizes can be sizes greater than 6 resource-block pairs. Additionally, each MTC carrier can also allocate resource-block pairs to a physical random access channel (PRACH). For example, as shown in FIG. 2, MTC carrier 1 can allocate the resource-block pairs of block 205 to PRACH. The PRACH of MTC carrier 1 can also overlap with the PRACH of MTC carrier 2.

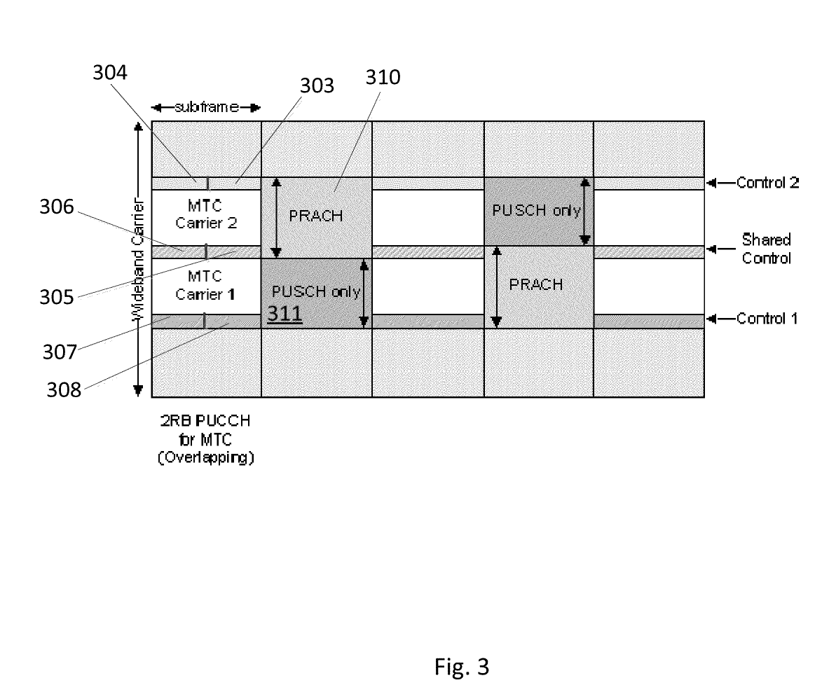

FIG. 3 illustrates, according to one embodiment, deploying carriers when two or more resource-blocks pairs are allocated per carrier to a control channel. In one embodiment, when two or more resource-block pairs are allocated per carrier to a control channel, the more than one narrowband carriers are deployed in an overlapping fashion where they share one or more PUCCH resource-block pairs in the frequency domain. As shown in FIG. 3, two resource-block pairs can be allocated per carrier to a control channel. For example, MTC carrier 2 has a first resource-block pair (303, 304) and a second resource-block pair (305, 306) allocated to a physical uplink control channel. MTC carrier 1 has a first resource-block pair (305, 306) and a second resource-block pair (307, 308) allocated to the physical uplink control channel. Resource-block pair (305, 306) is shared between MTC carrier 1 and MTC carrier 2.

In another embodiment, when the more than one narrowband carriers are deployed in a staggered or overlapping fashion, the control channels corresponding to the narrowband carriers can share at least one base sequence. A base sequence can be generally understood a sequence used for demodulation reference signals in a control channel such as, for example, a physical uplink control channel. For example, a PUCCH corresponding to each narrowband carrier can have the same base sequence as the PUCCH of another narrow band carrier. As such, PUCCH transmissions from different carriers can be configured to be orthogonal to each other.

In another embodiment, when the more than one narrowband carriers are deployed in a staggered or overlapping fashion, the physical random access channels (PRACHs) corresponding to the narrowband carriers are deployed in the same subframe, in an overlapping manner.

In another embodiment, when the more than one narrowband carriers are deployed in a staggered and/or overlapping fashion, the PRACH regions are staggered such that, when a PRACH is present in one narrowband carrier, the adjacent narrowband carrier can only support PUSCH transmissions in the corresponding subframe. For example, when PRACH 310 is present, the adjacent narrowband carrier supports a PUSCH transmission 311.

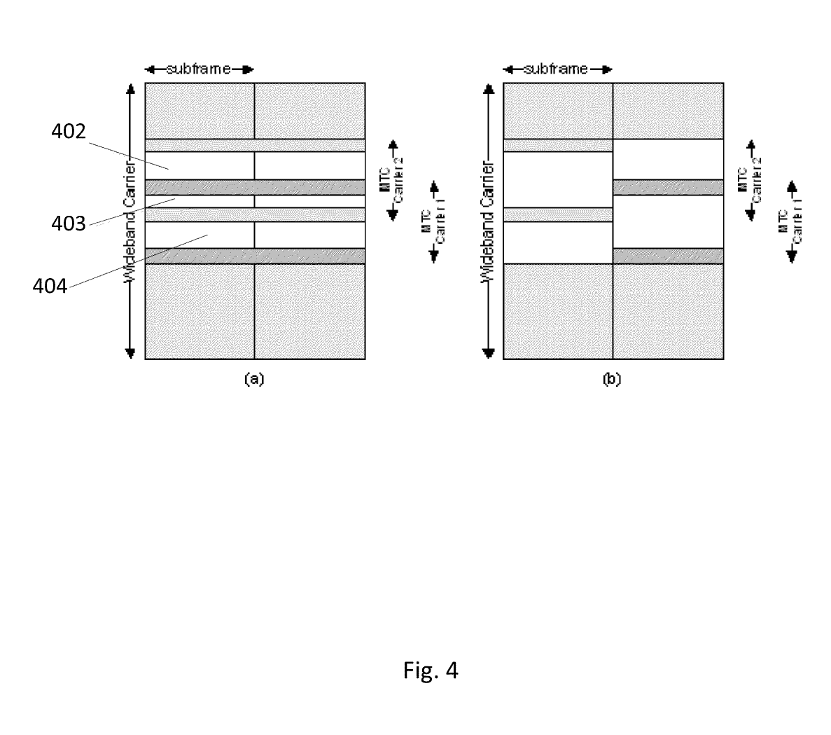

FIG. 4(a) illustrates, according to one embodiment, deploying multiple carriers where the carriers share one or more resource blocks. In one embodiment, more than one narrowband carriers are deployed in an overlapping fashion where they share one or more resource block-pairs in the frequency domain. As shown in FIG. 4(a), when more than one narrow-band carriers are overlapped, a resulting MTC region can be constructed. The resulting MTC region can be different in size than the six resource-block pairs corresponding to a single narrowband carrier. For example, as shown in FIG. 4(a), an MTC region of size 9 resource-block pairs can be constructed using two overlapping 1.4 MHz carriers. The constructed MTC region of 9 resource-block pairs can comprise the aggregation of regions 402, 403, and 404, for example.

FIG. 4(b) illustrates, according to another embodiment, deploying multiple carriers where the carriers share one or more resource blocks. As shown in FIG. 4(b), MTC regions of different sizes can be formed by deploying multiple narrow band carriers.

In another embodiment, when the more than one narrowband carriers are deployed in an overlapping fashion where they share one or more resource-block pairs in the frequency domain, the PUCCH can be configured in a time divisional multiplexing (TDM) fashion.

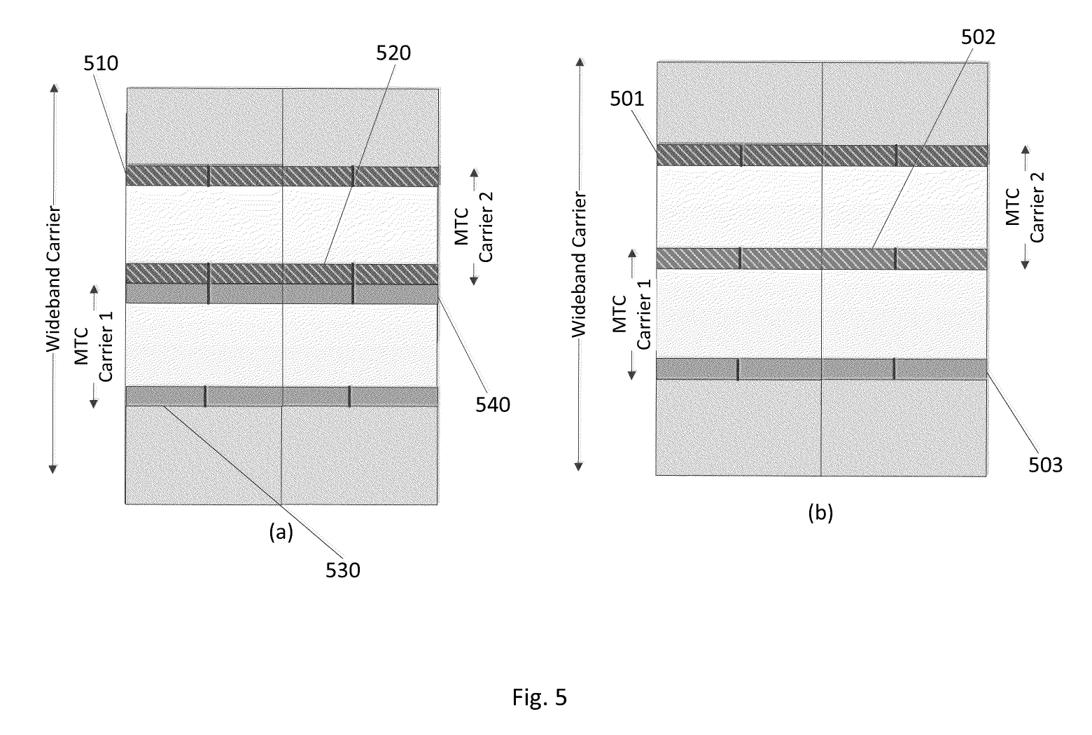

FIG. 5(a) illustrates control channel overhead when using two carriers according to one embodiment. As shown in FIG. 5(a), two carriers (MTC Carrier 1 and MTC Carrier 2) are deployed. Each carrier uses two resource-block pairs. For example, MTC Carrier 2 uses a first resource-block pair 510 and a second resource-block pair 520. MTC Carrier 1 uses a first resource-block pair 530 and a second resource-block pair 540. As previously described, each of MTC Carrier 1 and MTC Carrier 2 can comprise a plurality of resource-block pairs. Each resource-block pair of 510, 520, 530, and 540, comprises two resource blocks. As shown in FIG. 5(a), the total number of resource-block pairs between both MTC Carrier 1 and MTC Carrier 2 is 12 resource-block pairs. Specifically, of the 12 resource-block pairs, six resource-block pairs are from MTC Carrier 1 and six resource-block pairs are from MTC Carrier 2. Of these twelve resource-block pairs, four resource-block pairs are allocated to the PUCCH. Specifically, the four resource-block pairs are the resource-block pairs corresponding to resource-block pairs 510, 520, 530, and 540. These four resource-block pairs can be considered to be PUCCH overhead. Therefore, in the example shown in FIG. 5(a), the overall overhead between MTC Carrier 1 and MTC Carrier 2 is 33%. Specifically, a 33% overhead is determined based upon 4 resource-block pairs allocated to PUCCH divided by 12 total resource-block pairs.

FIG. 5(b) illustrates reductions in control channel overhead that can be achieved according to one embodiment. As shown in FIG. 5(b), in one embodiment, carriers can share a PUCCH region to reduce an overall PUCCH overhead between them. For example, in FIG. 5(b), MTC Carrier 1 and MTC Carrier 2 share a PUCCH region 502. Like the example shown in FIG. 5(a), the total number of resource-block pairs between both MTC Carrier 1 and MTC Carrier 2 (as shown in FIG. 5b) remains 12 resource-block pairs. Specifically, of the 12 resource-block pairs, six resource-block pairs are from MTC Carrier 1 and six resource-block pairs are from MTC Carrier 2. Of these twelve resource-block pairs, three resource-block pairs are allocated to the PUCCH. Specifically, the three resource-block pairs are the resource-block pairs corresponding to resource-block pairs 501, 502, and 503. Resource-block pair 502 is shared between MTC Carrier 1 and MTC Carrier 2. These three resource-block pairs can be considered to be the PUCCH overhead. Therefore, in the example shown in FIG. 5(b), the overall overhead between MTC Carrier 1 and MTC Carrier 2 is 25%. Specifically, a 25% overhead is determined based upon 3 resource-block pairs allocated to PUCCH divided by 12 total resource-block pairs. As such, by using the configuration shown in FIG. 5(b) instead of the configuration shown in 5(a), PUCCH overhead can be decreased from 33% to 25%.

In addition, as previously described, one embodiment also allows for expanding MTC regions in increments of finer granularity, when expanding MTC regions by deploying additional carriers. For example, suppose that the needed resources for supporting a plurality of low-cost MTC devices exceeds the resources provided by a single carrier band. Specifically, suppose that 9 resource-block pairs are needed to support all the low-cost MTC devices within the cell, whereas each single carrier can have 6 resource-block pairs.

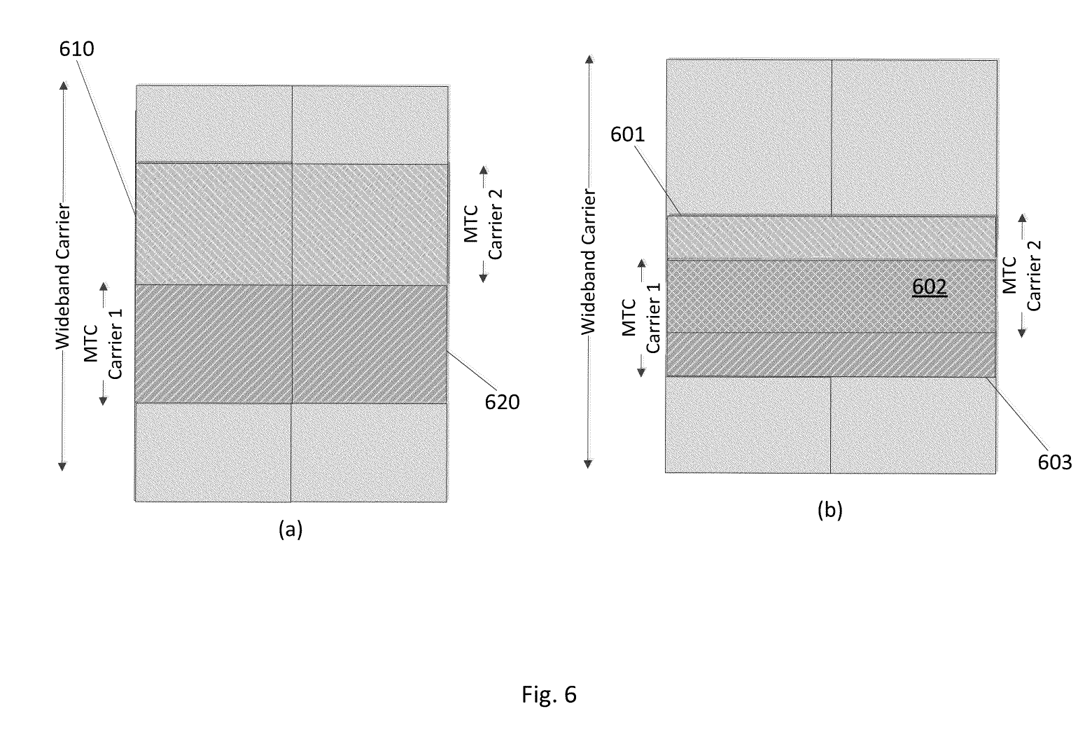

FIG. 6(a) illustrates an MTC region when using two carriers according to one embodiment. As shown in FIG. 6(a), if the carrier bands 610 and 620 are not overlapped, 2 separate carrier bands, taking up a total of 12 resource-block pairs, can be configured. Each of bands 610 and 620 take up six resource-block pairs, for example. However, by allowing carriers bands to overlap, certain embodiments can reduce the number of resource-block pairs that are used.

FIG. 6(b) illustrates achieving increments of finer granularity when forming/expanding MTC regions according to one embodiment. As shown in FIG. 6(b), if the carrier bands 601 and 603 are overlapped at 602, the 2 separate carrier bands can form an aggregate region taking up a total of 9 resource-block pairs. With the aggregation of two separate 1.4 MHz carriers taking up only 9 resource-block pairs, three resource-block pairs can be used for other services as compared to the configuration shown by FIG. 6(a).

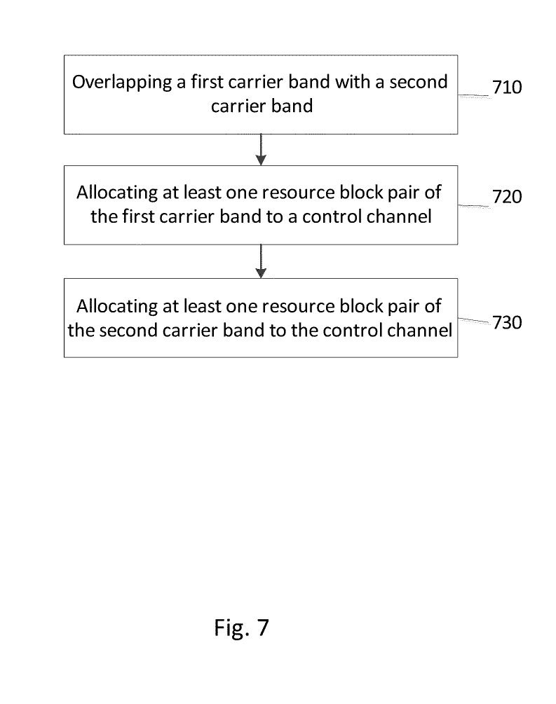

FIG. 7 illustrates a logic flow diagram of a method according to an embodiment. The method illustrated in FIG. 7 includes, at 710, overlapping a first carrier band with a second carrier band. At 720, one embodiment allocates at least one time-frequency resource of the first carrier band to a first channel. At 730, one embodiment allocates at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

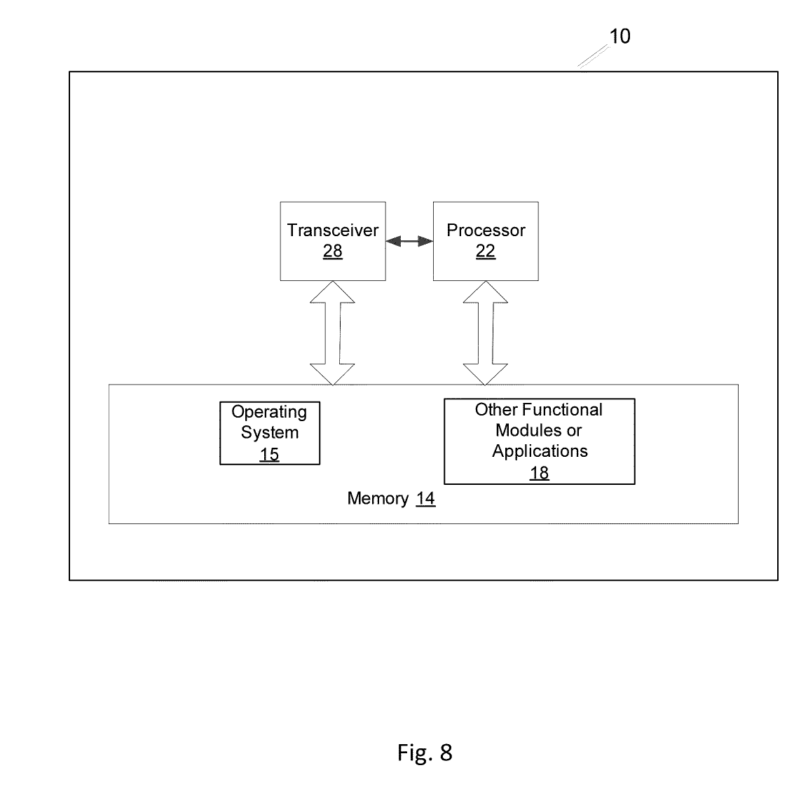

FIG. 8 illustrates an apparatus 10 according to another embodiment. In an embodiment, apparatus 10 can be a transmitting system, such as a base station, for example. In other embodiments, apparatus 10 can be a receiving device, such as an MTC device, for example.

Apparatus 10 can include a processor 22 for processing information and executing instructions or operations. Processor 22 can be any type of general or specific purpose processor. While a single processor 22 is shown in FIG. 8, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

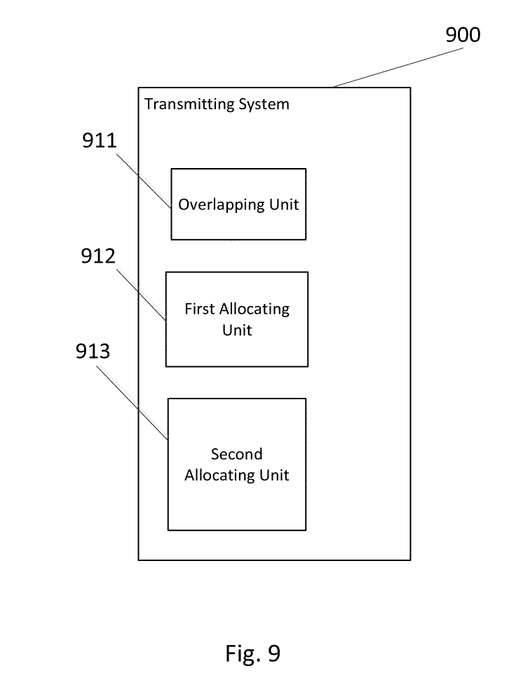

FIG. 9 illustrates an apparatus according to another embodiment. In an embodiment, apparatus 900 can be a transmitting system. Apparatus 900 can include overlapping unit 911 configured to overlap a first carrier band with a second carrier band. Apparatus 900 can also include first allocating unit 912 configured to allocate at least one time-frequency resource of the first carrier band to a first channel. Apparatus 900 can also include second allocating unit 913 configured to allocate at least one time-frequency resource of the second carrier band to a second channel. The first carrier band and the second carrier band share at least one time-frequency resource within the overlapping portion between the first carrier band and the second carrier band. The shared at least one time-frequency resource is allocated to at least one of the first and second channels.

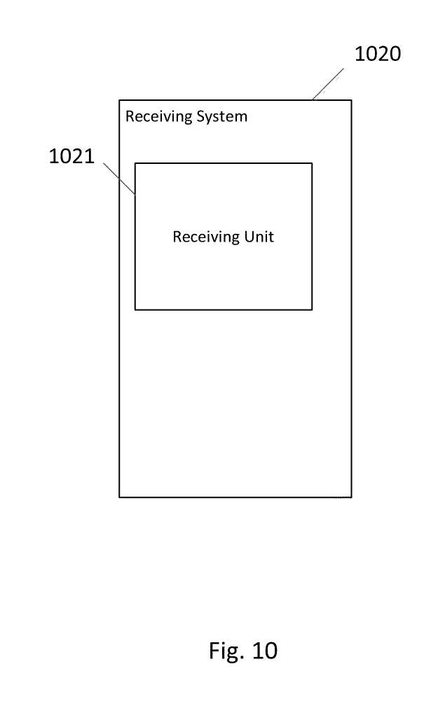

FIG. 10 illustrates an apparatus according to another embodiment. In an embodiment, apparatus 1020 can be a receiving system. Apparatus 1020 can include a receiving unit 1021 configured to receive transmissions via a first carrier band. At least a portion of the first carrier band overlaps a second carrier band. The transmissions comprise at least one time-frequency resource that is allocated to a first channel. The transmissions further comprise at least one time-frequency resource shared by the first carrier band and the second carrier band within the overlapping portion between the first carrier band and the second carrier band, and the shared time-frequency resource is allocated to the first channel.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
overlapping a first carrier band with a second carrier band;
allocating at least one time-frequency resource of the first carrier band to a first channel; and
allocating at least one time-frequency resource of the second carrier band to a second channel, wherein the first carrier band and the second carrier band share at least one time-frequency resource within the overlapping portion between the first carrier band and the second carrier band, and the shared at least one time-frequency resource is allocated to at least one of the first and second channels.

2. The method according to claim 1, wherein overlapping the first carrier band with the second carrier band comprises overlapping the first carrier band with the second carrier band within a wider carrier band.

3. The method according to claim 1, wherein the overlapping portion contains a control channel.

4. The method according to claim 1, wherein the at least one time-frequency resource of the first carrier band and the at least one time-frequency resource of the second carrier band are configured to use time-division multiplexing.

5. The method according to claim 1, wherein the first carrier band and the second carrier band share at least one control-channel base sequence.

6. The method according to claim 1, wherein the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

7. The method according to claim 1, wherein at least one of the first carrier band and the second carrier band transmits machine-type communications.

8. An apparatus, comprising:
at least one processor; and
at least one memory including computer program code,
the at least one memory and the computer program code configured, with the at least one processor, to cause the apparatus at least to
overlap a first carrier band with a second carrier band;
allocate at least one time-frequency resource of the first carrier band to a first channel; and
allocate at least one time-frequency resource of the second carrier band to a second channel, wherein the first carrier band and the second carrier band share at least one time-frequency resource within the overlapping portion between the first carrier band and the second carrier band, and the shared at least one time-frequency resource is allocated to at least one of the first and second channels.

9. The apparatus according to claim 8, wherein overlapping the first carrier band with the second carrier band comprises overlapping the first carrier band with the second carrier band within a wider carrier band.

10. The apparatus according to claim 8, wherein the overlapping portion contains a control channel.

11. The apparatus according to claim 8, wherein the at least one time-frequency resource of the first carrier and the at least one time-frequency resource of the second carrier band are configured to use time-division multiplexing.

12. The apparatus according to claim 8, wherein the first carrier band and the second carrier band share at least one control-channel base sequence.

13. The apparatus according to claim 8, wherein the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

14. The apparatus according to claim 8, wherein at least one of the first carrier band and the second carrier band transmits machine-type communications.

15. A computer program product, embodied on a computer readable medium, the computer program product configured to control a processor to perform a process, comprising:
overlapping a first carrier band with a second carrier band;
allocating at least one time-frequency resource of the first carrier band to a first channel; and
allocating at least one time-frequency resource of the second carrier band to a second channel, wherein the first carrier band and the second carrier band share at least one time-frequency resource within the overlapping portion between the first carrier band and the second carrier band, and the shared at least one time-frequency resource is allocated to at least one of the first and second channels.

16. A method, comprising:
receiving, by a receiving device, transmissions via a first carrier band, wherein at least a portion of the first carrier band overlaps a second carrier band, the transmissions comprise at least one time-frequency resource that is allocated to a first channel, the transmissions further comprise at least one time-frequency resource shared by the first carrier band and the second carrier band within the overlapping portion between the first carrier band and the second carrier band, and the shared time-frequency resource is allocated to the first channel.

17. The method according to claim 16, wherein receiving transmissions via the first carrier band comprises receiving transmissions via the first carrier band overlapping the second carrier band within a wider carrier band.

18. The method according to claim 16, wherein the overlapping portion contains a control channel.

19. The method according to claim 16, wherein the at least one time-frequency resource of the first carrier band and the at least one time-frequency resource of the second carrier band are configured to use time-division multiplexing.

20. The method according to claim 16, wherein receiving transmissions via the first carrier band comprises receiving the transmissions by a machine-type communications device.

21. The method according to claim 16, wherein the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

22. An apparatus, comprising:
at least one processor; and
at least one memory including computer program code,
the at least one memory and the computer program code configured, with the at least one processor, to cause the apparatus at least to
receive, by a receiving device, transmissions via a first carrier band, wherein at least a portion of the first carrier band overlaps a second carrier band, the transmissions comprise at least one time-frequency resource that is allocated to a first channel, the transmissions further comprise at least one time-frequency resource shared by the first carrier band and the second carrier band within the overlapping portion between the first carrier band and the second carrier band, and the shared time-frequency resource is allocated to the first channel.

23. The apparatus according to claim 22, wherein receiving transmissions via the first carrier band comprises receiving transmissions via the first carrier band overlapping the second carrier band within a wider carrier band.

24. The apparatus according to claim 22, wherein the overlapping portion contains a control channel.

25. The apparatus according to claim 22, wherein the at least one time-frequency resource of the first carrier band and the at least one time-frequency resource of the second carrier band are configured to use time-division multiplexing.

26. The apparatus according to claim 22, wherein receiving transmissions via the first carrier band comprises receiving the transmissions by a machine-type communications device.

27. The apparatus according to claim 22, wherein the first carrier band allocates a plurality of time-frequency resources to a first physical random access channel and to a first physical uplink shared channel, the second carrier band allocates a plurality of time-frequency resources to a second physical random access channel and to a second physical uplink shared channel, the first physical random access channel shares a same subframe as the second physical uplink shared channel, and the first physical uplink shared channel shares a same subframe as the second physical random access channel.

28. A computer program product, embodied on a computer readable medium, the computer program configured to control a processor to perform a process, comprising:
receiving, by a receiving device, transmissions via a first carrier band, wherein at least a portion of the first carrier band overlaps a second carrier band, the transmissions comprise at least one time-frequency resource that is allocated to a first channel, the transmissions further comprise at least one time-frequency resource shared by the first carrier band and the second carrier band within the overlapping portion between the first carrier band and the second carrier band, and the shared time-frequency resource is allocated to the first channel.

29. A system, comprising:
a first apparatus, comprising:
at least one first processor; and
at least one first memory including first computer program code,
the at least one first memory and the first computer program code configured, with the at least one first processor, to cause the first apparatus at least to
overlap a first carrier band with a second carrier band;
allocate at least one time-frequency resource of the first carrier band to a first channel; and
allocate at least one time-frequency resource of the second carrier band to a second channel, wherein the first carrier band and the second carrier band share at least one time-frequency resource within the overlapping portion between the first carrier band and the second carrier band, and the shared at least one time-frequency resource is allocated to at least one of the first and second channels; and
a second apparatus, comprising:
at least one second processor; and
at least one second memory including second computer program code,
the at least one second memory and the second computer program code configured, with the at least one second processor, to cause the second apparatus at least to
receive, by a receiving device, transmissions via the first carrier band, wherein at least a portion of the first carrier band overlaps the second carrier band, the transmissions comprise the at least one time-frequency resource that is allocated to the first channel, the transmissions further comprise the at least one time-frequency resource shared by the first carrier band and the second carrier band within the overlapping portion between the first carrier band and the second carrier band, and the shared time-frequency resource is allocated to the first channel.
